(19) United States
(12) Patent Application Publication
(10) Pub. No.: US 2025/0279736 A1
(43) Pub. Date: Sep. 4, 2025

(54) METHOD FOR ABSORBING ENERGY IN AN ELECTRIC DRIVE SYSTEM, AND ELECTRIC DRIVE SYSTEM

(71) Applicant: BODE - DIE TÜR GMBH, Kassel (DE)

(72) Inventors: Gerd GLÄSEL, Niestetal (DE); Markus HERMANN, Immenhausen (DE)

(21) Appl. No.: 18/858,090

(22) PCT Filed: Feb. 15, 2023
(86) PCT No.: PCT/EP2023/053784

§ 371 Date: Oct. 18, 2024

(30) Foreign Application Priority Data
Apr. 20, 2022 (DE) 10 2022 109 523.1

(51) Int. Cl. H02P 3/22; E05F 15/603

(52) U.S. Cl. CPC H02P 3/22; E05F 15/603; E05Y 2400/302; E05Y 2400/65; E05Y 2900/531

(57) ABSTRACT

A method for absorbing energy in an electric drive system, particularly a drive system for operating an entry system or door system of a vehicle, the system: includes an electric drive motor for driving a drive body; and a motor control circuit for controlling the drive of the drive motor. Electric energy is supplied in a controlled manner to the drive motor via the motor control circuit in a driving operating mode and electric energy is absorbed by the drive motor via the motor control circuit in a braking operating mode. Optionally at least one part of the absorbed energy is converted into heat in a controlled manner by an ohmic resistor of the drive system by injecting an alternating current into the drive system. An electric drive system is related, particularly a drive system for operating an entry system or door system of a vehicle, controlled by the method.

### CROSS-REFERENCE TO RELATED APPLICATIONS

This application is a 35 U.S.C. § 371 National Stage patent application of PCT/EP2023/053784, filed on 15 Feb. 2023, which claims the benefit of German patent application 10 2022 109 523.1, filed on 20 Apr. 2022, the disclosures of which are incorporated herein by reference in their entirety.

### TECHNICAL FIELD

The disclosure relates to a method for energy absorption in an electric drive system, in particular a drive system for an entry- or door system of a vehicle, and such an electric drive system.

### BACKGROUND

In such drive systems, which for example—but without mandatory restriction—are used for entry- or door systems of road and rail vehicles, a drive body, e.g. door wing, ramp, step and suchlike, is operated electrically by means of at least one electric motor. The regulating of the door run can take place with a cascaded regulator structure, which can have for example a current regulator, a speed regulator and a position regulator.

In order to reach or to maintain the speed specified by the position regulator, a current default value is calculated by the speed regulator, which is implemented by the current regulator. During an opening and closing process, the motor runs through all four operating quadrants I-IV, namely forward travel (I), forward braking (II), rearward travel (III) and rearward braking (IV) through the acceleration and deceleration phases occurring in both drive directions with a so-called four-quadrant operation (cf. FIG. 1). In the drive mode, the electric machine operates as a motor and converts electric energy into mechanical energy and assists its movement. In the braking mode, the electric machine operates as a generator and converts mechanical energy into electric energy and thereby opposes movement. The motor can basically operate both in forward and also in rearward direction (i.e. in drive- and braking processes).

With the above-mentioned regulator structure, the starting value of the current regulator acts (i.e. through pulse pattern or respectively duty cycle) on the control of a so-called motor bridge. In a conventional embodiment, the motor bridge, as is illustrated by way of example in FIG. 2, consists of two half-bridges, the centre point of which is respectively connected to a motor pole M1+, M1−, and an intermediate circuit capacitor C_{ZK}.

During operation of the motor in the quadrants I and III, the motor bridge delivers energy to the motor, whereas in the quadrants II and IV energy must be absorbed by the motor from the motor bridge. In several cases, a feeding back of the energy absorbed by the motor into the upstream supply network is not possible. The reason for this can be e.g. a rectifier between the supply network and the motor bridge, which does not permit a return flow into the supply network.

In this case, the energy absorption by the motor must be stopped as soon as the voltage in the intermediate circuit capacitor has reached the maximum permissible value. The absorption capability of the intermediate circuit capacitor is limited here by its capacity and the maximum permissible voltage.

In the design of an intermediate circuit capacitor for an electrically driven entry- or respectively door system, at least the energy, stored as kinetic energy, at maximum speed of movement in the door system, must be able to be absorbed by the intermediate circuit capacitor. The energy stored on a braking into the intermediate circuit capacitor is supplied to the door system again at the next acceleration process, so that the intermediate circuit capacitor is capable of absorbing for the next braking of the door system. With this design, the voltage of the intermediate circuit capacitor does not reach the maximum permissible voltage in normal operation on the level.

With such a design, however, the following special cases are not covered:
single-winged door system with inclination of the vehicle (e.g. a stop on a slope)
application of force through vandalism (e.g. person/passenger attempts to accelerate the door)

The two special cases make provision that energy must be absorbed by the motor from the motor bridge, so that the prescribed speed can be maintained by the speed regulator. In the case of single-winged door systems with inclination of the vehicle, the necessary energy absorption capability of the intermediate circuit capacitor can be determined or respectively calculated and taken into consideration by means of simulation.

In the case of an application of force through vandalism, the energy which is introduced into the door system is dependent on the force (vandalism by one or more persons) and the duration of the application. A design of the intermediate circuit capacitor with respect to the case of vandalism is not possible in most instances on grounds of space and cost.

To increase the energy absorption capability of the intermediate circuit, it is known in industrial frequency converters to use braking resistors which, in braking processes of the electric machine, convert the fed back energy into heat. Additional braking resistors, including control- and monitoring circuitry, entail costs and installation space which are not compatible with the requirements for door control apparatus in vehicles (e.g. passenger transport).

In door control apparatus, the voltage of the intermediate circuit capacitors is limited passively by means of voltage-limiting components (e.g. varistors, TVS diodes etc.), or respectively the energy absorption is terminated by switching off the motor bridge. Voltage-limiting components are subject to ageing and, to protect the components, their energy absorption capability must not be exceeded (difficult design). A switching off of the motor bridge leaves behind an easily movable door system, which in certain circumstances, on further application of force, moves quickly into the end position and is damaged mechanically.

### SUMMARY

Against this background, the disclosure is based on the problem of providing a method for energy absorption in an electric drive system, for example for the operation of an entry- or door system of a vehicle, and an electric drive system which guarantee a reliable, enduring, efficient and secure operation for example of the entry/door system. The method and the drive system are to be able to be implemented in a structurally simple and cost-efficient manner.

This problem is solved by a method with the features claimed herein and by an electric drive system with the features claimed herein. Further, particularly advantageous, embodiments of the disclosure are disclosed by the respective subclaims.

It is to be pointed out that the features presented individually in the claims can be combined in any desired, technically expedient manner (also over category boundaries, for example between method and device) and indicate further configurations of the disclosure. The description characterizes and specifies the disclosure additionally in particular in connection with the figures.

It is to be further noted that a conjunction “and/or”, used herein, standing between two features and linking these to one another, is always to be interpreted such that in a first configuration of the subject according to the disclosure only the first feature can be present, in a second configuration only the second feature can be present, and in a third configuration both the first and also the second feature can be present.

Furthermore, a term “approximately”, which is used herein, is to indicate a tolerance range which the specialist in the art who is active in the present field regards as usual. In particular, the term “approximately” is to be understood to mean a tolerance range of the related value of up to a maximum of +/−20%, preferably up to a maximum of +/−10%.

In a method according to the disclosure for energy absorption in an electric drive system, in particular a drive system for the operation of an entry- or door system of a vehicle (e.g. land vehicle such as a road or rail vehicle, air or water craft), wherein the drive system has an electric drive motor for the drive of a drive body (e.g. door wing, a ramp or a step) and a motor control circuit for the drive control of the drive motor, electric energy is supplied in a controlled manner to the drive motor via the motor control circuit in a driving operating mode, and electric energy is absorbed by the drive motor via the motor control circuit in a braking operating mode. The method according to the disclosure makes provision that optionally at least one part of the absorbed energy is converted into heat in a controlled manner by an ohmic resistor of the drive system by injecting an alternating current into the drive system, i.e. actively through targeted action, but not through an inherently occurring, passive process, (also designated herein in an abbreviated manner as targeted or controlled energy conversion).

In particular, the heat development of each ohmic resistor (e.g. conductor), flowed through by current, always taking place on each operation of the drive system and hence unavoidable, is to be understood as inherent energy conversion process. However, this is not to be understood as energy conversion according to the disclosure. Instead, the disclosure discloses an energy conversion which is brought about as a result of the (additionally) injected alternating current in a targeted manner into the drive system, which per se substantially generates or respectively is to generate no drive power in the drive motor. The optional execution of the controlled energy conversion, i.e. the controlled activation and deactivation, takes place preferably according to predetermined operating criteria and/or operating states of the drive system. Here and in the following, an alternating current is to be understood to mean an electric current, the direction of which alternates cyclically or periodically. Accordingly, an alternating voltage is to be understood to mean an electric voltage, the polarity of which alternates cyclically or periodically.

Basically, in the case of the alternating current or respectively the alternating voltage it can be that the duration of the two directions of the current or respectively of the two polarities of the voltage and alternatively or additionally also the absolute value of the level of the two directions of the current or respectively of the two polarities of the voltage is different. In other words, the alternating current or respectively the alternating voltage does not have to be symmetrical either in terms of time or with regard to the level. According to a preferred embodiment, however, provision is made that in the case of the alternating current, the temporal duration of an interval of a current flow in a first direction corresponds to the temporal duration of an interval of a current flow in a direction opposed to the first direction. The alternating current would therefore be, as it were, temporally symmetrical.

A further preferred embodiment is characterized in that in the case of the alternating current, the absolute value of a current flow during an interval of the current flow in a first direction corresponds to the absolute value of a current flow during an interval of the current flow in a direction opposed to the first direction. Accordingly, the alternating current is then symmetrical in its absolute value. It is to be noted that the above statements concern the alternating, and hence the injected, current, and not the current as a whole. Generally, despite a symmetry of the alternating current, the current as a whole can not then have this symmetry.

Through targeted injecting of the alternating current into the drive system having at least the drive motor and the motor control circuit, the disclosure uses the electric resistance which is present in any case in the drive system (e.g. motor winding of the drive motor, electric connection/connecting lines, possible semiconductor switching elements of the motor control circuit etc.) for the conversion of electric energy or respectively electric power into heat. In this way, the energy or respectively the power does not have to be absorbed or respectively completely absorbed e.g. by an intermediate circuit capacitor of the motor control circuit. For this, no further (additional) components are necessary, as components of the drive system which are already present are used.

In the case of an application of force by vandalism for example, the energy which is introduced into the drive system or respectively into an entry- or door system driven thereby, is independent of the force (vandalism by one or more persons) and the duration of the application. The targeted energy conversion in the ohmic resistor(s) of the drive system makes it possible to reliably and securely overcome such cases of undetermined application of force without a specific, additional electric design of the drive system, for example of an intermediate circuit capacitor of the motor control. The drive system or respectively an entry- or door system of a vehicle can thus be operated reliably, securely, durably and efficiently.

It was found that for example in a case of vandalism, a typical power input of approximately 100 W or respectively in a range of approximately 50 W to 150 W is to be expected. As the power input through vandalism can only take place during a predetermined, limited drive section of the drive body, e.g. a run of a driven entry door, ramp or step, the duration of the power input is limited chronologically by the duration of the path of travel of the drive body from one end position into another end position. Consequently also the energy which is able to be inputted as a whole is limited. A thermal overloading of the components of the drive system can thus be ruled out with appropriate design of the components. A power loss of approximately 100 W with an ohmic total resistance in the drive system, assumed by way of example, of approximately 1 Ohm can be produced with a current to be injected of approximately 10 A. The ohmic power loss P is determined in a known manner from the ohmic resistance R, flowed through by a current I according to

$$P = R \cdot {I}^{2} .$$

In a particularly preferred further development of the disclosure, the inherent ohmic resistance of at least one electric component which is provided for a functional operation of the drive system, in particular e.g. electric current line(s), motor winding(s) of the drive motor and/or semiconductor switching element(s) of the motor control circuit (e.g. semiconductor switch of a motor bridge), is used for the controlled conversion of the energy into heat. Basically any electric component of the drive system, with an inherent ohmic resistor, which is provided for the implementation of the actual drive control of the drive motor is to be understood as such an electric component, so that a dedicated ohmic resistor which would be provided substantially only for energy conversion, can be dispensed with, which enables an implementation which is cost-effective and of compact design.

A frequency and/or a current intensity can be determined for the alternating current. The frequency and/or the current intensity of the alternating current which is to be injected can be determined in a non-recurring manner, e.g. after the manufacture and/or installation of the drive system, and hence established before the actual operation (i.e. predetermined). Alternatively or additionally, the frequency and/or current intensity can also be determined during the operation, i.e. in reaction to current operating conditions, and can be accordingly adapted automatically to these operating conditions (e.g. momentary mechanical resistance in the drive system, momentary application of force for example by an inclined mounting of the drive system, through a human intervention or similar). Hereby, the ohmic energy conversion can be controlled in a particularly efficient and precise manner.

According to a further advantageous embodiment of the disclosure, the frequency of the injected alternating current is selected such that this is higher than a mechanical time constant of the drive system, for example higher by a factor of at least 10, preferably up to a factor of 100. It may also be that the frequency of the injected alternating current is higher by a factor of at least 100. The mechanical time constant represents in a well-known manner a measurement for the mechanical reaction time of the drive system, therefore for example the reaction time of a motor rotation rate on changes to the motor terminal voltage. Thus, the desired alternating current for the targeted energy conversion can be injected into the drive system, which, however, substantially does not have an effect or does not noticeably have an effect on the acceleration or deceleration of the drive body, e.g. an entry door, ramp or step or similar. The frequency of the injected alternating current which is selected in such a manner is, in any case, not noticeable in the mechanical drive system.

Likewise in this sense, an advantageous further development of the subject of the disclosure makes provision that the frequency and current intensity of the injected alternating current are selected such that the temporal average of the injected current is zero. In other words, the alternating current additionally injected into the drive system has substantially no direct component. Likewise, it may be that in the case of the alternating current, the emitted electric energy during an interval of a current flow in a first direction corresponds to the emitted electric energy during an interval of a current flow in a direction opposed to the first direction. Consequently then the same amount of energy is used for both drive directions, so that as a result for the movement a net energy absorption of zero occurs. Through these variants, it can be ensured that the alternating current has substantially no, or respectively no noticeable, negative influence on acceleration- and deceleration processes of the drive system. The resulting acceleration and deceleration in the drive system through the injected alternating current cancel one another out.

According to yet a further preferred embodiment of the disclosure, the drive motor is regulated through the emission of a control value signal of at least one regulator, wherein a ripple signal for injecting the alternating current overlaps the control value signal. In particular, the ripple signal is formed with a frequency corresponding to the current which is to be injected, and/or with an amplitude corresponding to the current which is to be injected. This serves to ultimately generate the current which is to be injected with a specific frequency and/or with a specific current intensity, and enables an intervention, which is simple to implement, into a for example conventional regulator structure for the generating of the alternating, preferably high-frequency, current in the drive system or respectively drive motor.

The at least one regulator can comprise a plurality of regulators, in particular a current regulator, a speed regulator and/or a position regulator, which can preferably be arranged in a functionally cascaded or respectively nested manner. This means, for example, that the speed regulator supplies to the current regulator a current reference variable as control value signal dependent on a fed back actual speed of the drive motor, and that the position regulator supplies to the speed regulator a speed reference variable—again as control value signal—dependent on a fed back actual position of the drive motor or of the drive body driven thereby. Preferably likewise an actual current feeding the drive motor is supplied to the current regulator.

It is basically conceivable to also use different regulator/control structures than those mentioned above and to accordingly also inject the ripple signal to the drive system in another way. For example, it is conceivable that a ripple signal is injected directly to a pulse width-modulated (PWM) signal for the drive control of the drive motor. For this, for example, the duty cycle of the PWM signal can be manipulated or respectively changed directly, in order to achieve the effect according to the disclosure of the ripple signal in the drive system.

For as efficient and reliable an operation of the drive system as possible, according to a further development of the subject of the disclosure, at least one part of the electric energy absorbed by the drive motor via the motor control circuit can be stored in a rechargeable energy store, e.g. a capacitor. With a controlling of the drive motor by means of a motor bridge, which can have two half bridges for example, the energy store can be a so-called intermediate circuit capacitor.

If the energy absorbed by the drive motor is stored intermediately in an energy store, according to a yet further preferred embodiment it can be removed again from the energy store and supplied to the drive motor in its driving operating mode in a controlled manner via the motor control circuit. In this way, the energy store can be emptied entirely, in order to make available a maximum storage capacity for the next absorption. This increases the operating efficiency of the drive system still further.

Preferably, the electric energy absorbed by the drive motor can be firstly supplied to the energy store until a first predetermined electric and/or thermal threshold value is exceeded and, only after exceeding the first threshold value, the electric energy furthermore absorbed by the drive motor by means of injecting of the alternating current into the drive system can be converted into heat in a controlled manner. The threshold value can be e.g. a maximum/minimum storage capacity of the energy store, a maximum/minimum electric supply voltage at the energy store, a maximum/minimum temperature of the energy store and suchlike. In any case, the predetermined threshold value can be selected with the aim of guaranteeing at any time a secure and reliable operation of the drive system, in particular to protect electric components of the drive system from an overload and damage. For example, the energy store in this sense can be firstly charged completely before further energy absorbed by the drive system or respectively drive motor is converted into heat in a targeted manner, in order to protect the energy store from an overload/damage and, at the same time, to increase the operating efficiency of the drive system.

According to a yet further advantageous embodiment of the disclosure, on falling below a second predetermined electric and/or thermal threshold value, the controlled converting of the electric energy absorbed by the drive motor into heat is terminated, wherein the second threshold value differs from the first threshold value. In other words, through the establishing of the first and second threshold value according to the disclosure, a hysteresis is formed for the activation and deactivation of the targeted energy conversion. Depending on the physical amount to which the respective threshold value relates, e.g. storage capacity, height of the supply voltage, temperature and suchlike, the second threshold value can be smaller in terms of amount, e.g. as soon as a particular temperature of the energy store is fallen below (again) or the supply voltage at the energy store falls below (again) a particular value. Preferably, energy absorbed by the drive motor after terminating of the controlled energy conversion is stored again in the energy store until the threshold value is exceeded once again.

According to a particularly preferred embodiment of the subject of the disclosure, the drive system is configured such that the ohmic total resistance in the drive system which is available for the controlled conversion into heat has a value of 0.5 to 5 Ohm, preferably 1 Ohm to 5 Ohm, for example also approximately 1 Ohm, 2 Ohm, 3 Ohm or 4 Ohm and further intermediate values between 0.5 and 5 Ohm. It has been surprisingly found that such an ohmic total resistance guarantees an energy conversion sufficient for operating instances which are to be safeguarded such as, for example, vandalism, with an already low current of approximately 1 A which is to be injected. The method and the drive system can thus be implemented in a cost-effective and space-saving manner.

Basically, the method according to the disclosure which is disclosed herein is able to be applied generically and is able to be used accordingly with all such drive systems which have a drive body driven by at least one drive motor, wherein electric energy must be received or respectively absorbed by the motor control circuit in particular operating phases (e.g. braking processes).

According to a further aspect of the disclosure, an electric drive system, in particular for operating an entry- or door system of a vehicle (e.g. land vehicle such as road or rail vehicle, air or water craft) has an electric drive motor for the drive of a drive body (e.g. door wing, a ramp or a step) and a motor control circuit for the drive control of the drive motor, wherein electric energy is able to be supplied to the drive motor in a controllable manner in a driving operating mode via the motor control circuit, and electric energy is able to be absorbed by the drive motor in an braking operation mode via the motor control circuit. According to the disclosure, a control unit is provided, which is configured to carry out a method according to one of the embodiments descried herein, in order to control the drive motor.

It is to be understood that with respect to definitions of terms related to drive system and the effects and advantages of features according to drive system, the disclosure of appropriate definitions, effects and advantages of the method according to the disclosure are referred to in the full extent, and vice versa. A repetition of explanations of appropriately identical features, their effects and advantages can thus be dispensed with in favour of a more compact description, without such omissions being interpreted as a restriction for one of the disclosed subjects of the disclosure.

The motor control circuit of the drive system can be configured as a motor bridge, which may have for example two half bridges with several semiconductor switching elements.

According to a preferred further development, the drive system has at least one regulator for the regulating of the drive motor by emission of a control value signal, and a ripple generator, which is configured to generate a ripple signal for the injecting of the alternating current, which signal overlaps the control value signal. In the case of a plurality of regulators, these can be, for example, functionally cascaded or respectively nested. It can thus be that a speed regulator and a current regulator are configured and arranged such that the speed regulator supplies to the current regulator a current reference variable, to be regulated, as control value signal.

It is pointed out once again that basically also other regulator/control structures can be provided than those mentioned above, so that the ripple signal can also be injected to the drive system in a different manner. For this, the ripple signal can be imparted directly for example to a pulse width-modulated (PWM) signal for the drive control of the drive motor, for example through corresponding changing of the PWM duty cycle.

Particularly preferably, the drive system has an ohmic total resistance, available for the controlled conversion into heat, with a value of approximately 0.5 to approximately 5 Ohm, preferably approximately 1 Ohm to approximately 5 Ohm, wherein any desired intermediate values between 0.5 and 5 Ohm or respectively 1 and 5 Ohm are likewise to be comprised.

According to a preferred further development, the drive body of the drive system is a door wing, a ramp or a step of an entry system of a vehicle, e.g. road or rail vehicle in public transport. In this case, the control unit can be, for example, a central part of the control of the door system, of steps and ramps.

### BRIEF DESCRIPTION OF THE DRAWINGS

Further features and advantages of the disclosure will emerge from the following description of example embodiments of the disclosure, not to be understood in a restrictive manner, which is explained more closely in the following with reference to the drawings. In these drawings, there are shown schematically:

FIG. 1 four operating quadrants of an electric motor in four-quadrant operation,

FIG. 2 a circuit diagram of an embodiment, by way of example, of a motor bridge according to the prior art, and

FIG. 3 a block diagram of an example embodiment of an electric drive system according to the disclosure, which is controlled by an example embodiment of a method according to the disclosure.

### DETAILED DESCRIPTION OF THE DRAWINGS

In the various figures, parts which are equivalent with regard to their function are given the same reference numbers, so that these are generally also only described once.

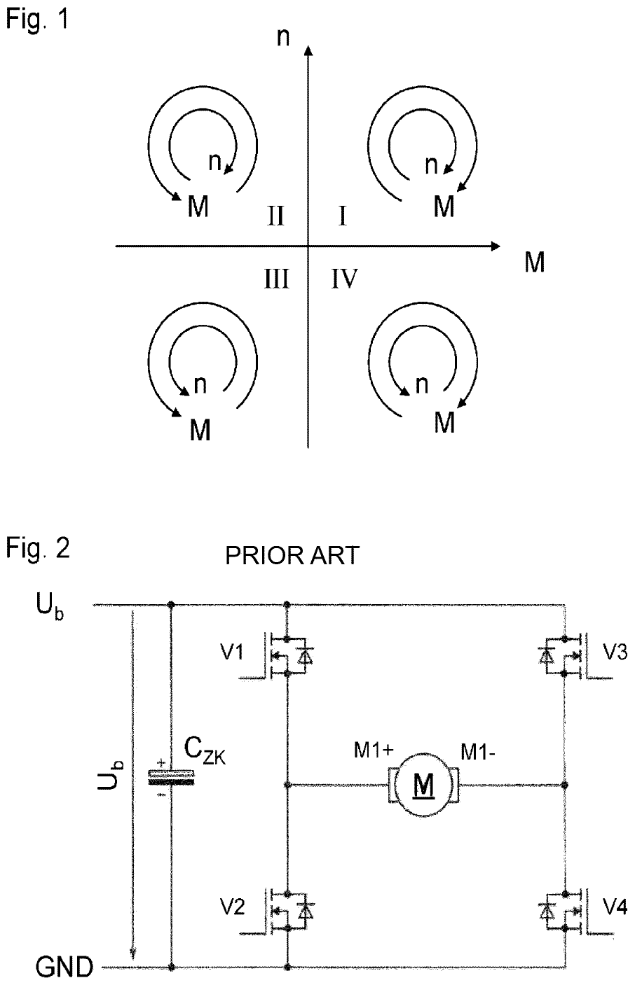

FIG. 1 represents four operating quadrants I, II, III and IV to illustrate a four-quadrant operation of a drive motor, wherein the quadrant I represents a forward travel process, quadrant II a forward braking process, quadrant III a rearward travel process and quadrant IV a reward braking process with the respectively indicated rotation direction n (positive value corresponds to clockwise direction) and of the acting torque M (positive value likewise corresponds to clockwise direction). In the drive mode, the electric machine operates as a motor and converts electric energy into mechanical energy and assists its movement. In the braking mode, the electric machine operates as a generator and converts mechanical energy into electric energy and thereby opposes the positive drive movement. The diagram of the four quadrant operation is generally known, so that further comments about this are dispensed with at this point.

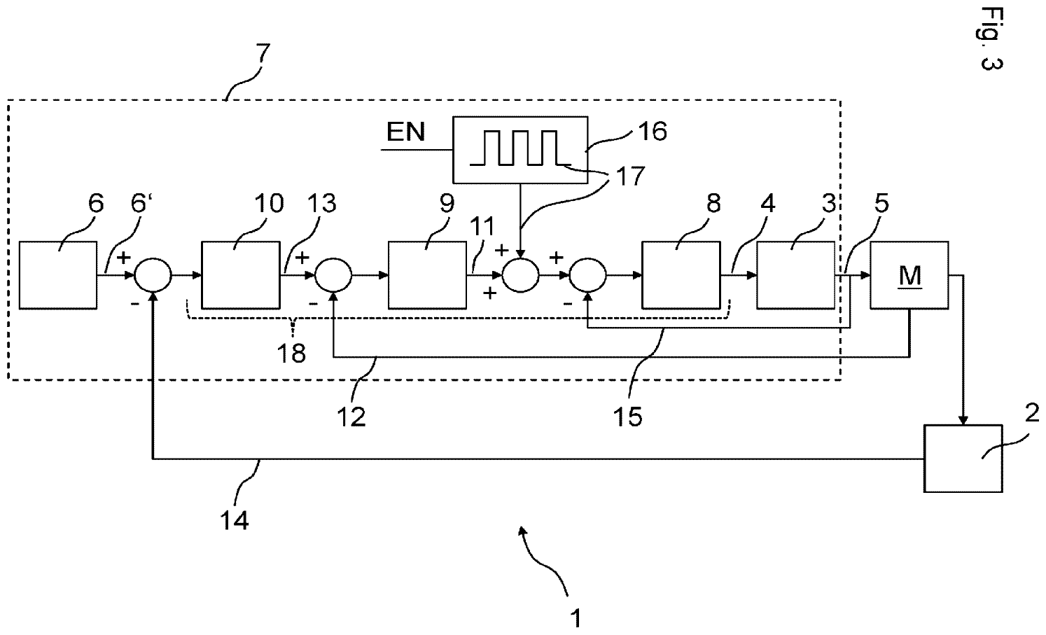

FIG. 2 represents a circuit diagram of an embodiment by way of example of a motor bridge according to the prior art. In such a conventional embodiment, the motor bridge, as illustrated in FIG. 2, consists of two half bridges with respectively two semiconductor switches V1 and V2 or respectively V3 and V4, wherein the centre points of the respective half bridges are respectively connected with a motor pole M1+ or respectively M1−. In addition, the motor bridge illustrated in FIG. 2 has an intermediate circuit capacitor C_{ZK}, in order to be able to store energy which is to be absorbed by the motor M (e.g. braking process).

During operation of the motor in the quadrants I and III, the motor bridge delivers energy to the motor, whereas in quadrants II and IV energy must be absorbed by the motor from the motor bridge. In many cases, a feeding back of the energy absorbed by the motor into the upstream supply network is not possible. The reason for this can be e.g. a rectifier between supply network and motor bridge, which does not permit a return flow into the supply network.

FIG. 3 represents a block diagram of an example embodiment of an electric drive system 1 according to the disclosure, which is controlled by an example embodiment of a method according to the disclosure. The present drive system 1 serves by way of example for the operation of an entry- or door system of a vehicle (both not illustrated), but is not necessarily restricted hereto. The vehicle is preferably a road or rail vehicle, e.g. bus or train. Other vehicles, for example also air and water craft, are also conceivable.

In FIG. 3 it can be seen that the drive system 1 has an electric drive motor M for the drive of a drive body 2, for example an entry door, step, ramp and suchlike. The motor M can be, for example and without mandatory restriction, a direct current servo motor. The drive system 1 has furthermore a motor control circuit 3 for the drive control of the drive motor M, which can be configured for example substantially in the manner of a motor bridge as illustrated in FIG. 2, without, however, being necessarily restricted hereto. The motor control circuit 3 can be actuated by a pulse width-modulated control signal (PWM signal) 5, in order to supply the drive motor 2 in a driving operating mode according to the PWM signal with a drive current and thus electric drive energy. The PWM signal 5 can be generated in a conventional manner based on a motor control specification 4 (e.g. a value of a PWM duty cycle which is to be applied), so that this is not entered into further herein. In a braking operating mode, electric energy is able to be absorbed by the drive motor M via the motor control circuit 3, as is described extensively in the general part of this description.

The motor control specification 4 results to a significant extent ultimately from a target position 6′ generated at the input side dependent on a specific type of operation of the drive system (e.g. opening/closing of the door system), which target position is provided by a position specification unit 6.

As a whole, the framework of the drive system 1, illustrated by way of example in dashed lines in FIG. 3, can be considered as control unit 7. However, it is to be understood that not all the components illustrated in FIG. 3 must necessarily be a component of one and the same control unit 7, but rather can also be provided outside the framework shown in FIG. 3, e.g. the position specification unit 6. Likewise, the control unit 7 can have further components which are not illustrated in FIG. 3. The control unit 7 can be formed substantially by a computing- and storage means, e.g. microprocessor, microcontroller etc. and memory in the form of e.g. RAM, ROM, flash etc. In any case, the control unit 7 is configured to carry out a method according to the disclosure as disclosed herein, in order to control the drive motor M.

In the example embodiment illustrated in FIG. 3, the drive system 1 has, as regulator 18, a current regulator 8, a speed regulator 9 and a position regulator 10 for the drive control of the drive motor M, which are associated here with the control unit 7. The current regulator 8, speed regulator 9 and position regulator 10, which constitute regulator 18, are arranged in the illustrated drive system 1 in a functionally nested manner, without, however, necessarily being restricted hereto. In other words, the speed regulator 9 here supplies to the current regulator 8 a current reference variable as control value signal 11 dependent on a fed back actual speed 12 of the drive motor M, and the position regulator 10 supplies to the speed regulator 9 a speed reference variable 13—which can also be understood as control value signal 11—dependent here on a fed back actual position 14 of the drive motor M, which correlates with an actual position of the drive body 2. An actual current 15, transmitted to the motor M, is supplied in a fed back manner to the current regulator 8. The motor control specification 4 can also be understood as control value signal 11.

As can be seen further from FIG. 3, the drive system 1 has a ripple generator 16 for the controlled generating of a ripple signal 17 illustrated schematically in FIG. 3 (e.g. substantially a square wave signal) with a frequency and amplitude. The ripple generator 16 can be activated and deactivated optionally via an activation signal EN, in order to accordingly switch the generating of the ripple signal 17 on and off. It can be seen in FIG. 3 that the ripple signal 17 is overlapped to the control value signal 11 of the current reference variable, so that the current regulator 8, in addition to the control value signal 11 emitted by the speed regulator 9 as current reference variable, which describes the drive current to be supplied for the actual drive of the motor M, also receives the overlapped ripple signal 17. Consequently, the current regulator 8, with activated ripple signal 17, generates a drive current which is overlapped by an alternating current with a frequency and current intensity which depend on the selected frequency and amplitude of the ripple signal 17. In other words, an additional alternating current can be optionally injected in a controlled manner into the drive system 1 or respectively into the drive motor M.

It is to be noted that the disclosure also includes other regulator-/control structures than those shown in FIG. 3, as the disclosure is not necessarily limited to the actual regulator-/control structure of the control unit 7 illustrated in FIG. 3. The ripple signal 17 can thus also be injected to the drive system 1 in another manner, not illustrated here. For example, the ripple signal 17 can also be injected to the motor control specification 4, so that as a result a changed PWM signal 5 occurs for the drive control of the drive motor M.

The additionally injected alternating current is used according to the disclosure to convert into heat in a controlled manner at least one part of the energy absorbed by the drive motor M through an ohmic resistor, which is provided inherently by the drive system 1, in order to absorb the part of the received energy.

The inherent ohmic resistor of the drive system 1 is formed by its electric components which are provided for a functional operation of the drive system 1, in particular electric current/connecting line(s), motor winding(s) of the drive motor M and/or semiconductor switching element(s) of a motor bridge of the motor control circuit 3, as are marked for example in FIG. 2 by the reference numbers V1-V4. An additional, dedicated ohmic resistor, which is used substantially solely for the controlled energy conversion, is not necessary, and also is not provided, in the drive system 1 according to the disclosure.

The drive system 1 according to the disclosure can be configured such that its total ohmic resistance available for the controlled conversion into heat has a value of 0.5 to 5 Ohm, preferably 1 Ohm to 5 Ohm including all intermediate values lying in the respective value ranges.

The frequency of the injected alternating current is preferably selected such that this is higher (e.g. by a factor 10 to 100 higher) than a mechanical time constant of the drive system 1, so that the additionally injected alternating current is not noticeable in the mechanical drive system 1. The frequency of the alternating injected current can be specified by means of the predetermined frequency of the generated ripple signal 17.

In particular, the frequency and current intensity of the injected alternating current is preferably selected such that the temporal average of the alternating current is zero and thus has substantially no direct component.

The motor control circuit 3 of the drive system 1 illustrated by way of example in FIG. 3 can have a rechargeable energy store, similar to the intermediate circuit capacitor C_{ZK} shown in FIG. 2, in order to store at least one part of the electric energy, absorbed by the drive motor M via the motor control circuit 3, in the energy store.

In such a case, energy from the energy store can also be supplied to the drive motor M in its driving operating mode in a controlled manner via the motor control circuit 3.

Particularly preferably, the electric energy absorbed by the drive motor M is firstly supplied to the energy store until a first predetermined electric and/or thermal threshold value is exceeded, and only after exceeding the first threshold value is the electric energy, furthermore absorbed by the drive motor M, by means of injecting of the alternating current, into the drive system 1 or respectively into the drive motor M, converted into heat in a controlled manner.

On falling below an optional second predetermined electric and/or thermal threshold value, the controlled converting into heat of the electric energy absorbed by the drive motor M can be terminated. For the formation of a hysteresis, the second threshold value can differ from the first threshold value. For the formation of a hysteresis, the second threshold value can differ from the first threshold value.

The method according to the disclosure which is disclosed herein for energy absorption in an electric drive system, in particular a drive system for the operation of an entry- or door system of a vehicle, and the electric drive system according to the disclosure, are not restricted to the actual embodiments respectively described herein, but rather also comprise further embodiments having the same effect, which result from technically expedient further combinations of the features of all subjects of the disclosure described herein. In particular, the features and feature combinations mentioned above in the general description and the description of the figures and/or the features and feature combinations shown solely in the figures, are able to be used not only in the combinations respectively explicitly indicated herein, but also in other combinations or in isolation, without departing from the scope of the present disclosure.

In a particularly preferred embodiment, the electric drive system according to the disclosure is used for the operation of an entry- or door system in a vehicle (e.g. land vehicle such as a road or rail vehicle, air- or water craft), wherein the drive system is controlled by a method disclosed herein for the controlling of such a drive system. The vehicle entry system preferably has a ramp and/or a step as drive body, the door system for example has a door wing as drive body.

1. A method for absorbing energy in an electric drive system, in particular a drive system for operating an entry system or door system of a vehicle, with an electric drive motor for driving a drive body, and with a motor control circuit for controlling the drive of the drive motor, wherein electric energy is supplied in a controlled manner to the drive motor via the motor control circuit in a driving operating mode and electric energy is absorbed by the drive motor via the motor control circuit in a braking operating mode, wherein optionally at least one part of the absorbed energy is converted into heat in a controlled manner by an ohmic resistor of the drive system by injecting an alternating current into the drive system.

2. The method according to claim 1,
wherein an inherent ohmic resistance at least of one electric component, which is provided for a functional operation of the drive system, electric current line(s), motor winding(s) of the drive motor and/or semiconductor switching element(s) of the motor control circuit, is used for the controlled conversion of the energy into heat.

3. The method according to claim 1,
wherein for the alternating current, a frequency and/or a current intensity is/are determined.

4. The method according to claim 1,
wherein the frequency of the injected alternating current is selected such that this is higher than a mechanical time constant of the drive system.

5. The method according to claim 3,
wherein the frequency and current intensity of the injected alternating current are selected such that its temporal average is zero.

6. The method according to claim 1,
wherein the drive motor is regulated through emission of a control value signal by at least one regulator, wherein a ripple signal for injecting the alternating current overlaps the control value signal.

7. The method according to claim 1,
wherein at least one part of the electric energy absorbed by the drive motor via the motor control circuit is stored in a rechargeable energy store.

8. The method according to claim 1,
wherein energy is supplied in a controlled manner to the drive motor in its driving operating mode from the energy store via the motor control circuit.

9. The method according to claim 7,
wherein the electric energy absorbed by the drive motor is firstly supplied to the energy store until a first predetermined electric and/or thermal threshold value is exceeded, and only after exceeding the first threshold value, the electric energy further absorbed by the drive motor by means of injecting the alternating current into the drive system is converted into heat in a controlled manner.

10. The method according to claim 1,
wherein on falling below a second predetermined electric and/or thermal threshold value, the controlled converting of the electric energy absorbed by the drive motor into heat is terminated, wherein the second threshold value differs from the first threshold value.

11. The method according to claim 1,
wherein the drive system is configured such that the total ohmic resistance in the drive system available for the controlled conversion into heat has a value of 0.5 to 5 Ohm.

12. An electric drive system, for operating an entry or door system of a vehicle, having an electric drive motor for the drive of a drive body, and a motor control circuit for the drive control of the drive motor, wherein electric energy is able to be supplied in a controlled manner to the drive motor via the motor control circuit in a driving operating mode and electric energy is able to be absorbed by the drive motor via the motor control circuit in a braking operating mode, wherein a control unit is provided, which is configured to carry out a method according to claim 1, in order to control the drive motor.

13. The drive system according to claim 12, wherein the drive system has at least one regulator for the regulating of the drive motor through emission of a control value signal and a ripple generator, which is configured, for the injecting of the alternating current, to generate a ripple signal which overlaps the control value signal.

14. The drive system according to claim 12,
whereby a total ohmic resistance, available for the controlled conversion into heat, with a value of 0.5 to 5 Ohm.

15. The drive system according to claim 12,
wherein the drive body is a door wing, a ramp, or a step.
